(19) United States
(12) Patent Application Publication
(10) Pub. No.: US 2017/0152615 A1
(43) Pub. Date: Jun. 1, 2017

(54) Adhesive fabric manufactured by Flat knitting Jacquard TECHNIQUE and surface molding method thereof

(71) Applicant: ASSEMS INC., Busan (KR)

(72) Inventors: Ji Sang JANG, Busan (KR); Jae Jung LEE, Busan (KR); Kyung Suk CHOI, Busan (KR); Bong Keun KWAK, Busan (KR)

(21) Appl. No.: 15/265,786

(22) Filed: Sep. 14, 2016

(30) Foreign Application Priority Data
Nov. 27, 2015 (KR) 10-2015-0167903

(51) Int. Cl. D04B 1/22; B32B 5/26

(52) U.S. Cl. CPC D04B 1/22; B32B 5/26; B32B 2250/03; B32B 2250/20; B32B 2262/0292; B32B 2262/0276; B32B 2262/0261; B32B 2262/062; B32B 2274/00; B32B 2307/51; B32B 2307/536; B32B 2437/02; B32B 2590/00

(57) ABSTRACT

The present invention relates to an adhesive fabric manufactured by a flat knitting Jacquard technique and a surface molding method thereof, and more particularly, to such an adhesive fabric manufactured by a flat knitting Jacquard technique, which is formed by weaving a yarn coated with a hotmelt resin or a TPU yarn and a fabric yarn by the flat knitting Jacquard technique, wherein an upper layer and a lower layer thereof are formed of the fabric yarn, and an intermediate layer thereof is formed of the yarn coated with a hotmelt resin or the TPU yarn, wherein the upper layer or the lower layer or the upper layer and the lower layer comprise a pattern formed thereon by a Jacquard weaving technique.

### CROSS-REFERENCE TO RELATED APPLICATIONS

This application claims the benefit of Korean Patent Application No. 10-2015-0167903, filed on Nov. 27, 2015 in the Korean Intellectual Property Office, which is incorporated herein by reference in its entirety.

### BACKGROUND OF THE INVENTION

1. Field of the Invention

The present invention relates to an adhesive fabric manufactured by a Jacquard flat knitting technique, which is formed by weaving a yarn coated with a hotmelt resin or a TPU yarn and a fabric yarn by the flat knitting Jacquard technique, wherein an upper layer and a lower layer thereof are formed of the fabric yarn, and an intermediate layer thereof is formed of the yarn coated with a hotmelt resin or the TPU yarn, and a method of surface-molding the same.

2. Description of Related Art

In general, products such as shoes, bags, wallets or various kinds of pouches are ones that have a fashion sense following a trend of the times. These products are configured such that parts (e.g., in case of a fabric for the shoe upper, the toe cap of the shoe, badge, logo, etc.) for achieving various ornamentations or reinforcements are sewn and bonded to a fabric.

However, such a sewing-based bonding method entails problems in that it is very complicated in process, and complex shaped sewing lines are formed on a fabric through a complicated sewing process so that a foreign substance such as soil, dust or the like are caught in the sewing lines or between gaps thereof during the long-term use thereof, thus leading to a degradation of fashionability, as well as the defective rate by the sewing lines is greatly increased through a number of sewing steps particularly in the manufacture process, thus leading to a reduction in productivity.

Therefore, recently, researches are actively in progress on a technology for bonding various kinds of parts to the fabric using a non-sewing method, and related prior arts include the following patent documents 1 to 3.

Specifically, a patent document 1 discloses a technology in which in a state where a thermoplastic material is laminated on a lower surface of a rubber sheet formed with a pattern, and the rubber sheet is attached to a fabric, the rubber sheet is bonded to the fabric by heating and compression through a non-sewing method. A patent document 2 discloses a technology in which an unvolcanized rubber material that has been pre-mixed and kneaded with a fabric of the shoe upper are cut off by a cutter into shoe parts such as a vamp, a side stripe, and a side check having a desired shape, which are in turn attached to the fabric for the shoe upper by an adhesive and then volcanized to cause the shoe parts to be integrally formed with the fabric for shoe upper. A patent document 3 discloses a technology in which a hotmelt film layer formed of a synthetic resin such as polyurethane is laminated on a shoe part which is in turn bonded to an adherend such as the shoe upper or the like by heat pressing using a non-sewing method.

However, the above-mentioned prior arts encounter problems in that various ornamental and reinforcing components (e.g., in the case of a fabric for the shoe upper, the toe cap of the shoe, a badge, a logo, etc.) are required to be manufactured separately and a process of bonding the components to the fabric is still complicated.

Further, in the case of conventional shoes (e.g., basketball shoes: control of landing or rotation of feet, and twisting or crisscrossing of feet) capable of restricting and controlling a shoe wearer′ body motion, the shoe upper is manufacture by using rubber with elasticity or textile with a feeling of rubber to implement the above function. However, the rubber or the textile with a feeling of rubber involves problems in that air permeability is never achieved to reduce the lifespan of the shoes as well as aggravate foot health, and in that various patterns cannot be formed to degrade the quality of products.

Meanwhile, a general fabric has a problem in that loosening of side strands, creasing and curling (i.e., a phenomenon that the fabric is rolled) occur at the time of cutting thereof according to the size of a width thereof after weaving the fabric, and thus the control of the width thereof is difficult, thus resulting in a degradation of product quality and productivity.

### PRIOR ART LITERATURE

### Patent Documents

Document 1: Korean Patent Laid-out Publication No. 10-2006-0102319 entitled “Vulcanized Rubber Sheet Bondable with Textile or Plastic by Pressing with Instantaneous Heat”

Document 2: Korean Utility Model Registration No. 20-0289939 entitled “Shoe Upper produced by Bonding (Pressing) and Vulcanizing Rubber on Fabric”

Document 3: Korean Patent Registration No. 10-1540774 entitled “Composite Fabric Sheet for Ornamentation”

### SUMMARY OF THE INVENTION

Accordingly, the present invention has been made to solve the aforementioned problems occurring in the prior art, and it is an object of the present invention to provide an adhesive fabric manufactured by a Jacquard flat knitting technique, which is formed by weaving a yarn coated with a hotmelt resin or a TPU yarn and a fabric yarn by the flat knitting Jacquard technique, wherein an upper layer and a lower layer thereof are formed of the fabric yarn, and an intermediate layer thereof is formed of the yarn coated with a hotmelt resin or the TPU yarn.

Another object of the present invention is to provide an adhesive fabric manufactured by a Jacquard flat knitting technique, in which a hotmelt resin or a TPU resin of an intermediate layer (i.e., a layer formed of a yarn coated with a hotmelt resin or a TPU yarn) is melt to be expressed and compressed only in one direction of the upper layer and the lower layer during the surface molding, and thus only a surface-molded portion of the adhesive fabric is expressed while creating a feeling of rubber or plastic with elasticity and the remaining portions thereof maintain flexibility of fibers as they are so that the surface-molded portion itself can replace a variety of ornamental or reinforcing components (e.g., the toe cap of a shoe, a badge, a logo, etc.) without separately sewing or bonding the ornamental or reinforcing components on the adhesive fabric by non-sewing, and thus various kinds of parts (e.g., shoe uppers, etc.) can be finished through a single process.

Still another object of the present invention is to provide an adhesive fabric manufactured by a Jacquard flat knitting technique, which can impart a hardness change according to each part of a shoe by applying an intrinsic function thereof and using a temperature difference or a step of a pattern portion of the mold, and allow a single fabric to impart a hardness difference (i.e., a different among soft, medium or hard hardness) among respective shoe parts through the hardness change.

Yet another object of the present invention is to provide an adhesive fabric manufactured by a Jacquard flat knitting technique, which can be applied to shoes (e.g., basketball shoes, etc.) capable of restricting and controlling a shoe wearer′ body motion to allow his or her body motion to be efficiently restricted and controlled by a surface-molded portion thereof and air permeability to be implemented wholly.

A further object of the present invention is to provide an adhesive fabric manufactured by a Jacquard flat knitting technique, which can express relatively various pattern and colors on the upper layer and the lower layer thereof compared to a fabric manufactured by a conventional simple flat knitting technique through the application of the flat knitting Jacquard technique, and can allow the surface-molded portion by the intermediate layer to naturally create a feeling of rubber or plastic with elasticity to further improve fashionability.

A still further object of the present invention is to provide an adhesive fabric manufactured by a Jacquard flat knitting technique, which can be applied to products after being subjected to a heat treatment process besides a surface molding process, and control a degree of heating to control the entire hardness and flexibility so that the adhesive fabric can be applied to various products.

A yet further object of the present invention is to provide an adhesive fabric manufactured by a Jacquard flat knitting technique, which allows the hotmelt resin or the TPU resin of the intermediate layer to be melt during the surface molding or the heat treatment to bond and couple surrounding fiber textures so that the loosening of strands, creasing and curling can be prevented, and makes the control of a width thereof easy so that the fabric can be knitted into various widths, but not a specified width, thus upgrading the quality of the corresponding fabric 20 and further improving productivity thereof.

To achieve the above objects, in one aspect, the present invention provides an adhesive fabric manufactured by a flat knitting Jacquard technique, which is formed by weaving a yarn 21 coated with a hotmelt resin or a TPU yarn and a fabric yarn 22 by the flat knitting Jacquard technique, wherein the adhesive fabric comprises an upper layer L1, and an intermediate layer L2, and a lower layer L3, wherein the upper layer L1 and the lower layer L3 are formed of the fabric yarn 22, and wherein the intermediate layer L2 is formed of the yarn 21 coated with a hotmelt resin or the TPU yarn.

Herein, preferably, the upper layer L1 or the lower layer L3 or the upper layer L1 and the lower layer L3 may include a pattern formed thereon by a Jacquard weaving technique.

Further, the yarn 21 coated with a hotmelt resin may be formed such that a hotmelt resin 21d is coated on the outer surface of a fabric yarn 21c consisting of a core 21a and a sheath 21b in an amount of 0.05-0.3 g/m². The fabric yarn 21c may preferably include a polyester yarn, a nylon yarn, and a cotton yarn, which are used alone or in combination of two or more thereof, and the hotmelt resin 21d may preferably include a polyester resin, a polyurethane resin, an acrylic resin, a polyimide resin, an ethylene vinyl acetate resin, and a polyolefin resin, which are used alone or in combination of two or more thereof.

In addition, the adhesive fabric manufactured by a flat knitting Jacquard technique may be formed by being subjected to heat treatment after having been manufactured.

In another aspect, the present invention provides a method for surface-molding an adhesive fabric manufactured by a flat knitting Jacquard technique, the method including: a step (S100) of manufacturing an adhesive fabric 20 by the flat knitting Jacquard technique; and a step (S200) of surface-molding the adhesive fabric 20 manufactured by the flat knitting Jacquard technique, wherein the adhesive fabric may include an upper layer L1, and an intermediate layer L2, and a lower layer L3, wherein the upper layer L1 and the lower layer L3 may be formed of the fabric yarn 22, wherein the intermediate layer L2 may be formed of the yarn 21 coated with a hotmelt resin or the TPU yarn, and wherein the upper layer L1 or the lower layer L3 or the upper layer L1 and the lower layer L3 may include a pattern formed thereon by a Jacquard weaving technique.

In the surface molding method, in step S200, preferably, the surface of the adhesive fabric 20 manufactured by the flat knitting Jacquard technique is compressed at a temperature of 90-140° C. and a pressure of 10-100 kg/cm² for 10-200 seconds using a mold so that the hotmelt resin 21d of the intermediate layer L2 formed of the yarn 21 coated with a hotmelt resin or a TPU resin of the intermediate layer L2 formed of the TPU yarn is melt to be expressed and compressed only in one direction of the upper layer L1 and the lower layer L3 to thereby surface-mold the adhesive fabric 20.

The present invention has an effect in that it provides the adhesive fabric manufactured by weaving the yarn coated with a hotmelt resin and the fabric yarn by the flat knitting Jacquard technique in such a manner that the upper layer and the lower layer thereof are formed of the fabric yarn, and the intermediate layer thereof is formed of the yarn coated with a hotmelt resin or the TPU yarn. Thus, the hotmelt resin or the TPU resin of the intermediate layer is melt to be expressed and compressed only in one direction of the upper layer and the lower layer during the surface molding, and thus only a surface-molded portion of the adhesive fabric is expressed while creating a feeling of rubber or plastic with elasticity and the remaining portions thereof maintain flexibility of fibers as they are. Therefore, the surface-molded portion itself of the adhesive fabric can replace a variety of ornamental or reinforcing components (e.g., the toe cap of a shoe, a badge, a logo, etc.) without separately sewing or bonding the ornamental or reinforcing components on the adhesive fabric by non-sewing, so that various kinds of parts (e.g., shoe uppers, etc.) can be finished through a single process.

In other words, the adhesive fabric manufactured by a Jacquard flat knitting technique can impart a hardness change according to each part of a shoe by applying an intrinsic function thereof and using a temperature difference or a step of a pattern portion of the mold, and allow a single fabric to impart a hardness difference (i.e., a different among soft, medium or hard hardness) among respective shoe parts through the hardness change.

Further, in the case where such an adhesive fabric 20 is applied to shoes (e.g., basketball shoes, etc.) capable of restricting and controlling a shoe wearer′ body motion, his or her body motion can be efficiently restricted and controlled by the surface-molded portion, and air permeability can be implemented wholly.

In addition, the inventive adhesive fabric can express relatively various pattern and colors on the upper layer L1 and the lower layer L3 thereof compared to a fabric manufactured by a conventional simple flat knitting technique through the application of the flat knitting Jacquard technique. Moreover, the adhesive fabric allows the surface-molded portion by the intermediate layer L2 to naturally create a feeling of rubber or plastic with elasticity to further improve fashionability.

In addition, the adhesive fabric itself can be applied to products after being subjected to a heat treatment process besides a surface molding process, and control a degree of heating thereof to control the entire hardness and flexibility so that the adhesive fabric can be applied to various products.

Further, the inventive adhesive fabric allows the hotmelt resin 21d or the TPU resin of the intermediate layer L2 to be melt during the surface molding or the heat treatment to bond and couple surrounding fiber textures so that the loosening of strands, creasing and curling can be prevented, and makes the control of a width thereof easy so that the fabric can be knitted into various widths, but not a specified width, thus upgrading the quality of the corresponding fabric 20 and further improving productivity thereof.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the present invention will be apparent from the following detailed description of the preferred embodiments of the invention when taken in conjunction with the accompanying drawings, in which:

FIG. 1 is a real photo showing the vertical cross section of an adhesive fabric manufactured by a flat knitting Jacquard technique according to the present invention;

FIG. 2 is a cross-sectional view illustrating a structure of a yarn coated with a hotmelt resin according to the present invention;

FIG. 3 is a flowchart illustrating a method for surface-molding an adhesive fabric manufactured by a flat knitting Jacquard technique according to the present invention;

FIG. 4A and FIG. 4B illustrate photos of a top plan view and a cross sectional view of an adhesive fabric manufactured by a flat knitting Jacquard technique according to the present invention before surface-molding the adhesive fabric;

FIG. 5A and FIG. 5B illustrate photos of a top plan view and a cross sectional view of an adhesive fabric manufactured by a flat knitting Jacquard technique according to the present invention after surface-molding the adhesive fabric;

FIG. 6A to FIG. 6D illustrate a photo of a top plan view of an upper of a shoe to which an adhesive fabric manufactured by a flat knitting Jacquard technique according to the present invention after surface-molding the adhesive fabric is applied; and

FIG. 7A to FIG. 7F and FIG. 8A to FIG. 8E illustrate photos of cross sectional views of temperature-specific hardnesses and state changes upon the heat treatment of an adhesive fabric manufactured by a flat knitting Jacquard technique according to the present invention after surface-molding the adhesive fabric.

### EXPLANATION ON SYMBOLS

20: adhesive fabric manufactured by flat knitting Jacquard
21: yarn coated with hotmelt resin
21a: core
21b: sheath
22, 21c: fabric yarn
21d: hotmelt resin
L1: upper layer
L2: intermediate layer
L3: lower layer

### DETAILED DESCRIPTION OF THE PREFERRED EMBODIMENTS

The present invention for achieving the above-mentioned effects is directed to an adhesive fabric manufactured by a flat knitting Jacquard technique and a surface molding method thereof. In the meantime, in the detailed description and the accompanying drawings, illustration and explanation on the construction and operation which a person skilled in the art can easily understand will be briefly made or will be omitted to avoid redundancy. In particular, illustration and explanation on the detailed technical construction and operation of elements, which have no direct connection with the technical features of the present invention, will be omitted, and only the technical constructions directly related with the present invention will be briefly illustrated and explained.

Hereinafter, an adhesive fabric manufactured by a flat knitting Jacquard technique and a surface molding thereof according to the present invention will be described in detail with reference to the accompanying drawings.

First, the adhesive fabric 20 manufactured by a flat knitting Jacquard technique according to the present invention is characterized by being formed by weaving a yarn 21 coated with a hotmelt resin or a TPU yarn and a fabric yarn 22 by a flat knitting Jacquard technique as shown in FIG. 1. The adhesive fabric includes an upper layer L1, and an intermediate layer L2, and a lower layer L3. The upper layer L1 and the lower layer L3 are formed of the fabric yarn 22, and the intermediate layer L2 is formed of the yarn 21 coated with a hotmelt resin or the TPU yarn. The upper layer L1 or the lower layer L3 or the upper layer L1 and the lower layer L3 comprise a pattern formed thereon by a Jacquard weaving technique (see FIGS. 4A, 4B, 5A, and 5B).

Herein, as described above, the upper layer L1 and the lower layer L3 basically is formed of the fabric yarn 22, and the intermediate layer L2 is formed of the yarn 21 coated with a hotmelt resin or the TPU yarn, but the yarn 21 coated with a hotmelt resin of the intermediate layer L2 may partly expressed on the surface of the upper layer L1 or the lower layer L3 depending on the kind, the type or the design aspect of a weaving machine.

As used herein, the phrase “flat knitting Jacquard” refers to an already well-known weaving method in which flat knitting-type weaving and jacquard-type weaving are mixed with each other.

More specifically, flat knitting refers to a method in which knitted fabrics are produced by weft knitting. That is, the flat knitting is also called horizontal knitting, i.e., a method in which a strand of yarn is connected longitudinally while forming a loop, and is an already well-known method in which the yarn is knitted to form a plurality of fiber plies (i.e., layers) while being reciprocated alternately from right to left and left to right or going around circularly. In addition, the knitting type, method and device for the flat knitting are known in various manners. Furthermore, Jacquard weaving is a weaving technique which was developed by Joseph Marie Jacquard in the early 19^{th} century. The Jacquard weaving is an already well-known weaving technique in which various kinds of yarns are combined in weaving to express various specific patterns on a fabric. In addition, the weaving type, method and device for the Jacquard weaving is already known in various manners.

In other words, the flat knitting Jacquard is a weaving technique in which a pattern is formed on a specific layer by the Jacquard weaving technique upon the formation of a plurality of layers. The weaving type, method and device for the flat knitting Jacquard is known already in various manners and is very variable depending on the use purpose and design of a corresponding fabric. Thus, the weaving type, method and device for the flat knitting Jacquard is not limited particularly, but all of the already known weaving type, method and device can be applied. However, in an embodiment of the present invention, as shown in FIG. 1,

The adhesive fabric is formed such that the upper layer L1 and the lower layer L3 thereof are formed of the fabric yarn 22, and the intermediate layer L2 thereof is formed of the yarn 21 coated with a hotmelt resin or the TPU yarn. A pattern is formed on the upper layer L1 or the lower layer L3 or the upper layer L1 and the lower layer L3 by the Jacquard weaving technique.

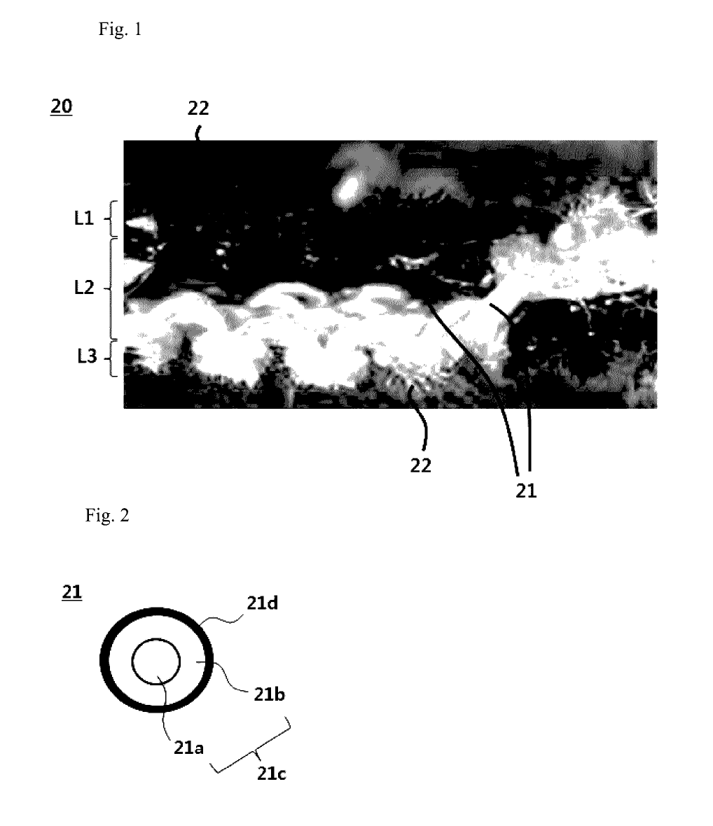

In the meantime, the yarn 21 coated with a hotmelt resin, which is used for the intermediate layer L2 of the adhesive fabric 20 manufactured by a flat knitting Jacquard technique, is formed such that a hotmelt resin 21d is coated on the outer surface of a fabric yarn 21c consisting of a core 21a and a sheath 21b in an amount of 0.05-0.3 g/m² as show in FIG. 2. If the coating amount of the hotmelt resin 21d is less than 0.05 g/m², the hotmelt resin 21d will not be sufficiently expressed and compressed during the surface molding, and if the coating amount of the hotmelt resin 21d exceeds 0.3 g/m², a defect will occur due to an excessive amount of the hotmelt resin when the adhesive fabric 20 is manufactured by a flat knitting Jacquard technique.

In this case, the fabric yarn 21c used in the present invention can include, but is not limited to, a polyester yarn, a nylon yarn, and a cotton yarn, which are used alone or in combination of two or more thereof, and the hotmelt resin 21d used in the present invention can include, but is not limited to, a polyester resin, a polyurethane resin, an acrylic resin, a polyimide resin, an ethylene vinyl acetate resin, and a polyolefin resin, which are used alone or in combination of two or more thereof.

Herein, the hotmelt resin 21d can be coated on the fabric yarn 21c irrespective of the kind of the fabric yarn 21c, but if the fabric yarn 21 is the polyester yarn, the polyester resin or the polyurethane resin is preferably coated on the fabric yarn 21c in consideration of fusibility between the fabric yarn 21c and the hotmelt resin 21d. In addition, if the fabric yarn 21c is the nylon yarn, the acrylic resin or the polyimide resin is preferably coated on the fabric yarn 21c, and if the fabric yarn 21c is the cotton yarn, the ethylene vinyl acetate resin or the polyolefin resin is preferably coated on the fabric yarn 21c.

In addition, the fabric yarn 22, which is knitted together with the yarn 21 coated with a hotmelt resin to constitute the upper layer L1 and the lower layer L3, can also include, but is not limited to, a polyester yarn, a nylon yarn, and a cotton yarn, which are used alone or in combination of two or more thereof.

Meanwhile, the TPU (thermoplastic polyurethane) yarn refers to yarn manufactured by extruding or coating a TPU resin, which is a kind of yarn that is already known in the art, and thus the detailed description thereof will be omitted to avoid redundancy.

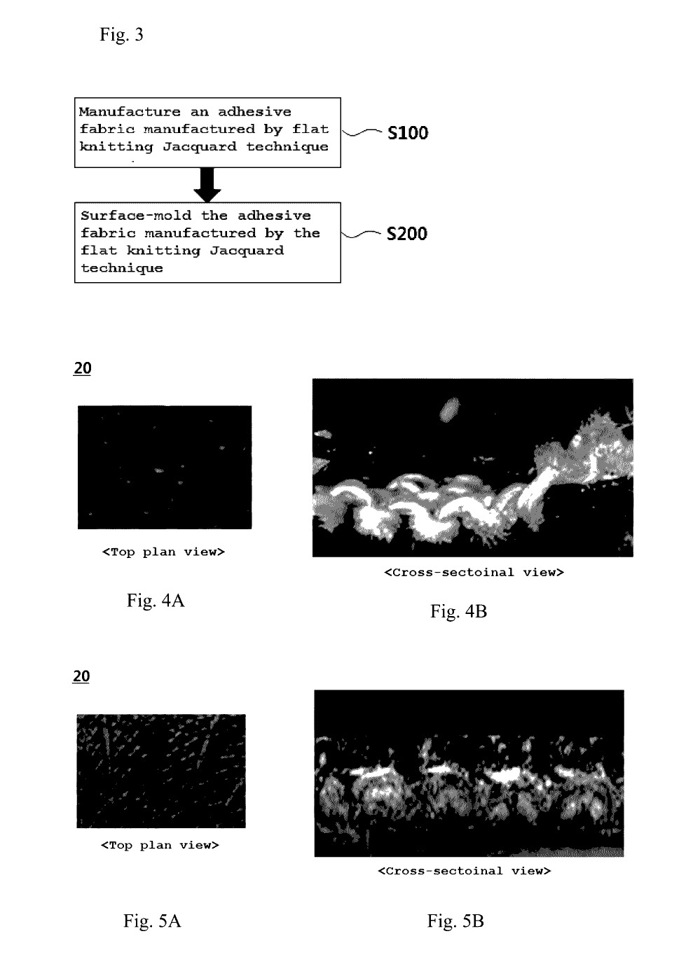

Next, the surface-molding method of an adhesive fabric manufactured by a flat knitting Jacquard technique according to the present invention includes a step (S100) of manufacturing an adhesive fabric 20 by the flat knitting Jacquard technique; and a step (S200) of surface-molding the adhesive fabric 20 manufactured by the flat knitting Jacquard technique as shown in FIG. 3.

The step (S100) is a step of manufacturing the adhesive fabric 20 by the flat knitting Jacquard technique, and the configuration and manufacturing method of the adhesive fabric 20 manufactured by the flat knitting Jacquard technique has been described above, and thus the detailed description will be omitted to avoid redundancy.

The step (200) is a step of surface-molding the adhesive fabric 20 manufactured by the flat knitting Jacquard technique. As shown in FIG. 4A and FIG. 4B, the surface of the adhesive fabric 20 manufactured by the flat knitting Jacquard technique is compressed at a temperature of 90-140° C. and a pressure of 10-100 kg/cm² for 10-200 seconds using a mold formed with a desired pattern (intagliated or embossed) so that the hotmelt resin 21d or the TPU resin of the intermediate layer L2 formed of the yarn 21 coated with a hotmelt resin or the TPU yarn is melt to be expressed and compressed only in one direction of the upper layer L1 and the lower layer L3 (i.e., state of being expressed only in a direction of the upper layer L1 on the drawing) to thereby surface-mold the adhesive fabric 20.

In the meantime, if the surface-molding conditions are beyond the above specified range, the hotmelt resin 21d or the TPU resin will not be expressed and compressed sufficiently in one direction during the surface molding.

Herein, the reason why the hotmelt resin 21d or a TPU resin of the intermediate layer L2 is melt to be expressed and compressed only in one direction of the upper layer L1 and the lower layer L3 is that it can be expressed and compressed by the shape or direction of the mold, but is ultimately determined by the surface molding conditions. That is, the hotmelt resin 21d or the TPU resin is expressed only in one direction at 90-140° C. but can be expressed in both directions at 141° C. or higher.

In other words, the present invention provides the adhesive fabric 20 manufactured by weaving the yarn 21 coated with a hotmelt resin and the fabric yarn 22 by the flat knitting Jacquard technique in such a manner that the upper layer L1 and the lower layer L3 thereof are formed of the fabric yarn 22, and the intermediate layer L2 thereof is formed of the yarn 21 coated with a hotmelt resin or the TPU yarn. Thus, the hotmelt resin 21d or the TPU resin of the intermediate layer L2 is melt to be expressed and compressed only in one direction of the upper layer L1 and the lower layer L3 during the surface molding, and thus only a surface-molded portion of the adhesive fabric 20 is expressed while creating a feeling of rubber or plastic with elasticity and the remaining portions thereof maintain flexibility of fibers as they are. Therefore, the surface-molded portion itself of the adhesive fabric 20 can replace a variety of ornamental or reinforcing components (e.g., the toe cap of a shoe, a badge, a logo, etc.) without separately sewing or bonding the ornamental or reinforcing components on the adhesive fabric 20 by non-sewing, so that various kinds of parts (e.g., shoe uppers, etc.) can be finished through a single process, the application of the function can impart a hardness change according to each part of a shoe using a temperature difference or a step of a pattern portion of the mold, and a single fabric can impart a hardness difference (i.e., a different among soft, medium and hard hardness) among respective shoe parts through the hardness change.

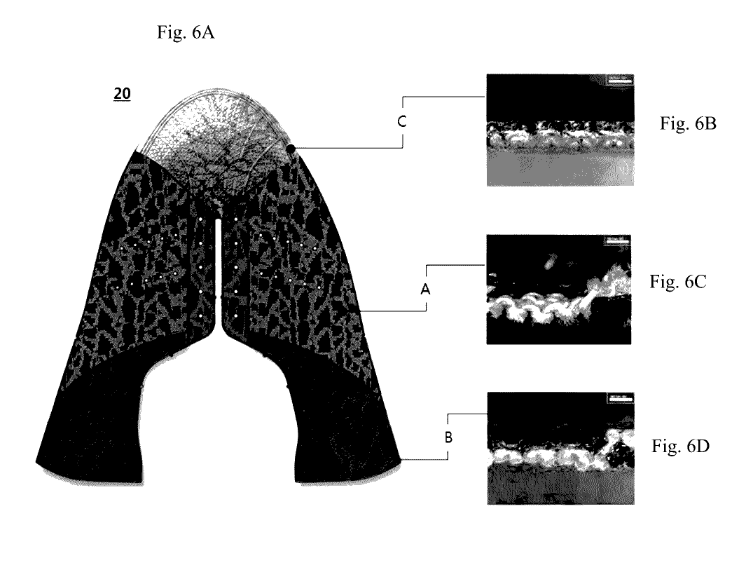

For example, in FIG. 6A to FIG. 6D, there is shown the case where the single fabric can impart a hardness difference (i.e., a difference among soft, medium and hard hardnesses) among respective shoe parts through the hardness change according to the temperature change during the surface molding. As shown in FIG. 6A to FIG. 6D, a part “B” having a medium hardness (e.g., ASTM D2813; reference hardness: 3.1-5.2) is formed by surface-molding a portion requiring a pattern or a reinforcement, or a part “C” having a hard hardness (e.g., ASTM D2813; reference hardness: 1.9-2.8) in a state in which a part “A” having a soft hardness (e.g., ASTM D2813; reference hardness: 6.1-6.5) is formed by heat-treating a corresponding fabric before the surface molding is performed. In the meantime, as described above, the hardness difference can be implemented depending on the temperature change as well as the step of the mold (a degree of protrusion of a compressed portion).

Herein, the temperature change necessary for implementing the hardness difference (i.e., a difference among soft, medium and hard hardnesses) can be variable depending on the kind of yarns, but is not particularly limited and various temperatures can be applied within a range of forming the hardness.

In addition, the soft, medium and hard hardnesses are merely examples and is not limited to the above-specified hardness range. The medium and hard hardnesses can vary depending on the kind or the use environment of products, the kind of the hotmelt resin or the yarn, and the like, on the assumption that the soft, medium and hard hardness are different among each other.

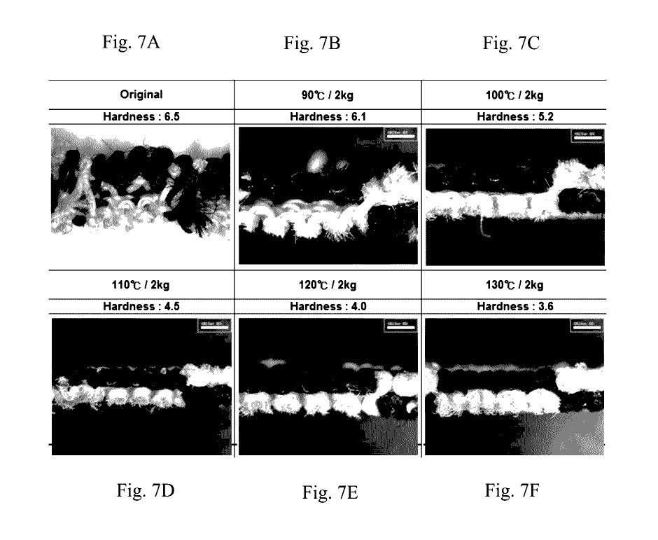

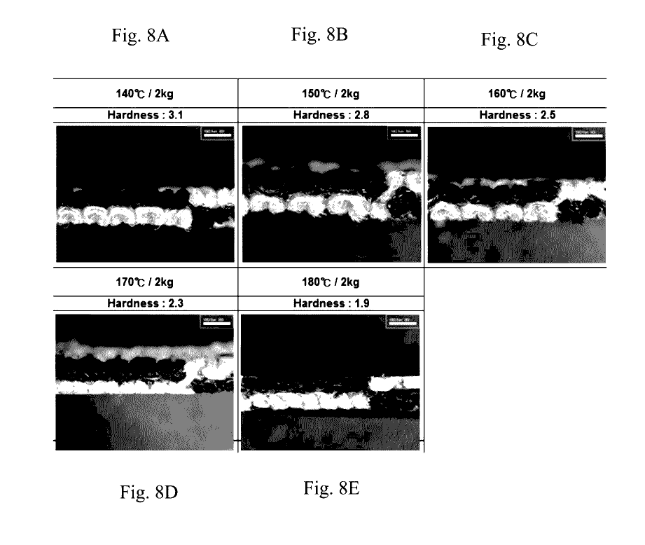

Meanwhile, the adhesive fabric 20 according to the present invention may be applied to products after being subjected to the heat treatment, but not the surface molding, or the heat treatment can be applied as a process of pretreating the fabric before the surface molding is performed. The hardness change may be implemented through the heat treatment, but not the surface molding. For example, as shown in FIGS. 7A-7F and FIGS. 8A-8E, a fabric that has a hardness of 6.5 (ASTM D2813 reference) and not heat-treated can implement a changed in hardness ranging from 1.9 to 6.5 by being subjected to heat treatment at 90˜180° C.

Herein, the concept of the heat treatment is different from that of the surface molding. In the case of the heat treatment, the hardness change is implemented in the above-specified range, but the hotmelt resin or the TPU resin is not expressed in one direction. In the case of the surface molding, a fabric is directly compressed to be surface-molded. As described above, the fabric is expressed in one direction at 90-140° C. during the surface molding, and is not expressed in one direction at 141° C. or higher.

In the meantime, the temperature change of the heat treatment described above and the hardness change according to the temperature change may vary depending on the kind of the hotmelt resin or the yarn.

In other words, a single fabric can impart a hardness difference among respective shoe parts through the hardness change so that when the hardness difference is applied to shoes (e.g., basketball shoes, etc.), a shoe wearer's body motion can be efficiently restricted and controlled by a surface-molded portion. In addition, it is possible improve both a functional aspect (functionality, productivity) of implementing air permeability wholly, and a design aspect (fashionability, quality upgrading) of expressing various patterns and colors and allowing the surface-molded portion to create a feeling of rubber or plastic with elasticity. Thus, the present invention can applied to a variety of products such as shoes, bags, wallets, various kinds of pouches, clothes, belts, etc.

Further, in the case where such an adhesive fabric 20 is applied to shoes (e.g., basketball shoes, etc.) capable of restricting and controlling a shoe wearer′ body motion, his or her body motion can be efficiently restricted and controlled by the surface-molded portion, air permeability can be implemented wholly. In addition, the inventive adhesive fabric 20 can express relatively various pattern and colors on the upper layer L1 and the lower layer L3 thereof compared to a fabric manufactured by a conventional simple flat knitting technique through the application of the flat knitting Jacquard technique. Moreover, the adhesive fabric allows the surface-molded portion by the intermediate layer L2 to naturally create a feeling of rubber or plastic with elasticity to further improve fashionability. In addition, the adhesive fabric 20 itself can be applied to products after being subjected to a heat treatment process besides a surface molding process, and control a degree of heating thereof (i.e., a degree of melting of the hotmelt resin 21d) to control the entire hardness and flexibility so that the adhesive fabric can be applied to various products. Further, the inventive adhesive fabric 20 allows the hotmelt resin 21d or the TPU resin of the intermediate layer L2 to be melt during the surface molding or the heat treatment to bond and couple surrounding fiber textures so that the loosening of strands, creasing and curling can be prevented, and makes the control of a width thereof easy so that the fabric can be knitted into various widths, but not a specified width, thus upgrading the quality of the corresponding fabric 20 and further improving productivity thereof.

As described above, while the adhesive fabric manufactured by a flat knitting Jacquard technique and the surface-molding method thereof according to the present invention has been described and illustrated in connection with specific exemplary embodiments with reference to the accompanying drawings, it will be readily appreciated by those skilled in the art that various modifications and changes can be made to the present invention within the technical spirit and scope of the present invention defined in the claims.

What is claimed is:

1. An adhesive fabric manufactured by a flat knitting Jacquard technique, which is formed by weaving a yarn 21 coated with a hotmelt resin or a TPU yarn and a fabric yarn 22 by the flat knitting Jacquard technique,
wherein the adhesive fabric comprises an upper layer L1, and an intermediate layer L2, and a lower layer L3,
wherein the upper layer L1 and the lower layer L3 are formed of the fabric yarn 22, and
wherein the intermediate layer L2 is formed of the yarn 21 coated with a hotmelt resin or the TPU yarn.

2. The adhesive fabric manufactured by a flat knitting Jacquard technique according to claim 1, wherein the upper layer L1 or the lower layer L3 or the upper layer L1 and the lower layer L3 comprise a pattern formed thereon by a Jacquard weaving technique.

3. The adhesive fabric manufactured by a flat knitting Jacquard technique according to claim 1, wherein the yarn 21 coated with a hotmelt resin is formed such that a hotmelt resin 21d is coated on the outer surface of a fabric yarn 21c consisting of a core 21a and a sheath 21b in an amount of 0.05-0.3 g/m²,
wherein the fabric yarn 21c comprises a polyester yarn, a nylon yarn, and a cotton yarn, which are used alone or in combination of two or more thereof, and
wherein the hotmelt resin 21d comprises a polyester resin, a polyurethane resin, an acrylic resin, a polyimide resin, an ethylene vinyl acetate resin, and a polyolefin resin, which are used alone or in combination of two or more thereof.

4. The adhesive fabric manufactured by a flat knitting Jacquard technique according to claim 1, wherein the adhesive fabric manufactured by the flat knitting Jacquard technique is formed by being subjected to heat treatment after having been manufactured.

5. A method for surface-molding an adhesive fabric manufactured by a flat knitting Jacquard technique the method comprising:
a step (S100) of manufacturing an adhesive fabric 20 by the flat knitting Jacquard technique; and
a step (S200) of surface-molding the adhesive fabric 20 manufactured by the flat knitting Jacquard technique,
wherein the adhesive fabric comprises an upper layer L1, and an intermediate layer L2, and a lower layer L3, wherein the upper layer L1 and the lower layer L3 are formed of the fabric yarn 22, wherein the intermediate layer L2 is formed of the yarn 21 coated with a hotmelt resin or the TPU yarn, and wherein the upper layer L1 or the lower layer L3 or the upper layer L1 and the lower layer L3 comprise a pattern formed thereon by a Jacquard weaving technique.

6. The method according to claim 5, wherein in step S200, preferably, the surface of the adhesive fabric 20 manufactured by the flat knitting Jacquard technique is compressed at a temperature of 90-140° C. and a pressure of 10-100 kg/cm² for 10-200 seconds using a mold so that the hotmelt resin 21d of the intermediate layer L2 formed of the yarn 21 coated with a hotmelt resin or a TPU resin of the intermediate layer L2 formed of the TPU yarn is melt to be expressed and compressed only in one direction of the upper layer L1 and the lower layer L3 to thereby surface-mold the adhesive fabric 20.
